(19) United States
(12) Patent Application Publication
(10) Pub. No.: US 2015/0134090 A1
(43) Pub. Date: May 14, 2015

(54) ELECTRONIC DEVICES AND AUDIO SIGNAL PROCESSING METHODS

(71) Applicant: HTC Corporation, Taoyuan-City (TW)

(72) Inventors: Chen-Yu WANG, Taoyuan City (TW); Jen-De CHEN, Taoyuan City (TW); Chien-Hung LIN, Taoyuan City (TW)

(73) Assignee: HTC Corporation, Taoyuan-City (TW)

(21) Appl. No.: 14/075,980

(22) Filed: Nov. 8, 2013

(51) Int. Cl. G06F 3/16; G05B 15/02

(52) U.S. Cl. CPC G06F 3/165; G05B 15/02
USPC 700/94

(57) ABSTRACT

An electronic device includes an acoustic sensor, a storage module, a signal-processing unit and a processor unit. The acoustic sensor is configured to receive a sound and generate a sound signal according to the sound. The signal-processing unit is coupled to the acoustic sensor for receiving the sound signal, processing the sound signal according to setting data and accordingly generating an audio signal. The processor unit is coupled to the signal-processing unit, obtaining first position data of the electronic device, determining the setting data according to the first position data and storing the audio signal in the storage module.

### BACKGROUND OF THE INVENTION

1. Field of the Invention

The application relates to an electronic device, and more particularly to an electronic device capable of providing optimum recording quality.

2. Description of the Related Art

Portable electronic devices have become important tools for communication in recent years. With the maturity and popularity of mobile communication networks and corresponding products, the conversation quality and additional functions of the portable electronic devices always keep increasing. Therefore, portable electronic devices have been used much more frequently than before.

For example, there are more and more people discarding traditional digital cameras and directly using the camera module equipped in portable electronic devices to take pictures. In another example, since some conventional recording mediums, such as recording pens, may not be available at places where users use portable electronic devices, there are more and more people using the recording functionality provided by the portable electronic devices for recording.

Since using the multi-functional portable electronic devices is a trend nowadays, how to further improve the quality of the functionality provided by the portable electronic devices is a topic of interest.

### BRIEF SUMMARY OF THE INVENTION

Electronic devices and audio signal processing methods are provided. An exemplary embodiment of an electronic device comprises an acoustic sensor, a storage module, a signal-processing unit and a processor unit. The acoustic sensor is configured to receive a sound and generate a sound signal according to the sound. The signal-processing unit is coupled to the acoustic sensor for receiving the sound signal, processing the sound signal according to setting data and accordingly generating an audio signal. The processor unit is coupled to the signal-processing unit, obtaining first position data of the electronic device, determining the setting data according to the first position data and storing the audio signal in the storage module.

An exemplary embodiment of an audio signal processing method comprises: receiving a sound by an electronic device and generating a sound signal according to the sound; obtaining first position data of the electronic device and determining setting data according to the first position data; and processing the sound signal according to the setting data to generate an audio signal.

A detailed description is given in the following embodiments with reference to the accompanying drawings.

### BRIEF DESCRIPTION OF DRAWINGS

The application can be more fully understood by reading the subsequent detailed description and examples with references made to the accompanying drawings, wherein:

FIG. 1 shows a block diagram of an electronic device according to an embodiment of the application;

FIG. 2 shows a flow chart of an audio signal processing method according to an embodiment of the application; and

FIG. 3 shows a flow chart of an audio signal processing method according to another embodiment of the application.

### DETAILED DESCRIPTION OF THE INVENTION

The following description is of the best-contemplated mode of carrying out the application. This description is made for the purpose of illustrating the general principles of the application and should not be taken in a limiting sense. The scope of the application is best determined by reference to the appended claims.

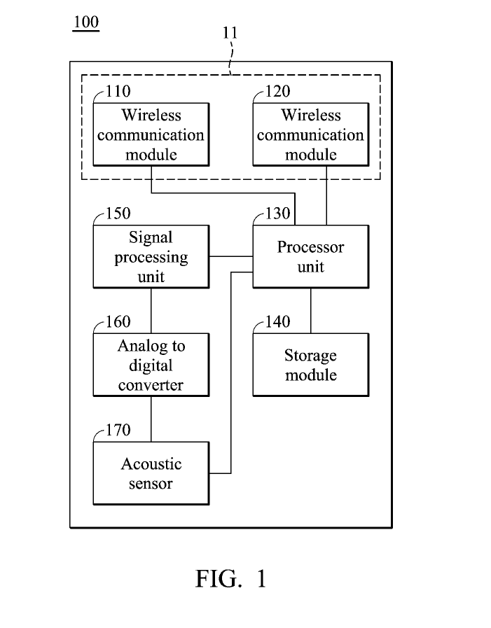

FIG. 1 shows a block diagram of an electronic device according to an embodiment of the application. The electronic device 100 may be a portable electronic device, such as a tablet, a cellular phone, a personal digital assistant, etc. The electronic device 100 may comprise a wireless module 11, which may comprise at least one wireless communication module, such as the wireless communication modules 110 and 120. The wireless communication modules 110 and 120 may respectively provide wireless communication services in compliance with different wireless communication protocols. For example, according to an embodiment of the application, the wireless communication module 110 may be a Satellite Navigation System (SNS) signal receiver configured to receive at least an SNS signal, and the wireless communication module 120 may be a Global System for Mobile Communications (GSM) communication module, a Universal Mobile Telecommunications System (UMTS) communication module, a Wireless Fidelity (WiFi) communication module, a Worldwide Interoperability for Microwave Access (WiMax) communication module, a Long Term Evolution (LTE) communication module, a Bluetooth communication module, or any communication module developed based on the above-mentioned communication technology, and may comprise a corresponding RF transceiver and a corresponding baseband signal processing device (not shown in the figure). The RF transceiver may generate RF signals in compliance with the corresponding wireless communication protocol and transmit the RF signals to an air interface or receive the RF signals from the air interface. The baseband signal processing device may process baseband signals in compliance with the corresponding wireless communication protocol.

The electronic device 100 may further comprise a processor unit 130, a storage module 140, a signal-processing unit 150, an analog-to-digital converter 160 and an acoustic sensor 170. The acoustic sensor 170 is configured to receive a sound and generate a sound signal according to the sound. For example, the acoustic sensor 170 may be triggered in response to a recording start indication signal to start receiving the sound and recording, so as to generate a sound signal. The sound signal may be an analog signal. The recording start indication signal may be generated by the processor unit 130 according to the user's operation. For example, when the user execute the recording program and/or press the recording button (no matter whether the recording button is a physical button or a button shown via the User Interface), the processor unit 130 may generate a corresponding recording start indication signal so as to trigger the acoustic sensor 170 to start recording. The analog sound signal may be converted into a digital form via the analog-to-digital converter 160 and may be processed by the signal-processing unit 150, so as to generate the audio signal. The signal-processing unit 150 may process the sound signal by amplifying, attenuating, filtering, and/or noise cancelling, so as to generate the audio signal.

According to an embodiment of the application, the signal-processing unit 150 may process the sound signal according to a plurality of different setting data so as to obtain optimum recording quality. For example, in an embodiment of the application, one or more of the wireless communication modules 110 and 120 may keep positioning or locating a current position of the electronic device 100 according to the received wireless signal and the wireless communication module 110/120 may generate first position data according to the current position and store the first position data in the storage module 140 or directly provide the first position data to the processor unit 130. Note that in the embodiments of the application, the wireless communication module 110/120 may continuously and automatically update the first position data in the background (for example, not displaying the first position data on the screen or not affecting the operation of the user) according to the latest positioning result, such that the first position data may always be synchronous with the actual position of the electronic device 100. In addition, note that the first position data is not limited to an outdoor position or a predetermined address, and may comprise information regarding which floor of a building, which area, room number, or others.

According to another embodiment of the application, when the wireless communication module 110 is configured to receive an SNS signal, the processor unit 130 may further determine longitude and latitude data of the electronic device 100 according to the SNS signal and may transmit the longitude and latitude data to a server, such as a cloud server, via the wireless communication module 120. Next, the processor unit 130 may further receive the first position data of the electronic device generated by the server based on the longitude and latitude data via the wireless communication module 120.

According to yet another embodiment of the application, the storage module 140 may store a plurality of schedule records input by the user in a calendar (which may be a software application program or a database), and the processor unit 130 may obtain the user information, such as a current position of the user and the electronic device 100, the place and content of an activity that the user is currently or going to engage in, according to the schedule records of the user and a current time. The processor unit 130 may also take the position data retrieved from the schedule records as the first position data when the current position of the electronic device 100 is unable to be positioned via the wireless signal.

Since the position result and the user's schedule records can be obtained any time, in the embodiments of the application, the processor unit 130 may obtain the first position data and the user data of the electronic device any time. In other words, in the embodiments of the application, the obtaining of the first position data and the user information is not limited to be taken place before or after the beginning of recording of the acoustic sensor 170.

According to an embodiment of the application, the storage module may further be configured to store one or more second position data and the setting data corresponding to the second position data. The processor unit 130 may further determine whether the first position data matches the second position data stored in the storage module and when the processor unit 130 determines that the first position data matches the second position data, the signal-processing unit 150 may process the sound signal according to the setting data corresponding to the second position data to generate the audio signal. The processor unit 130 may further store the audio signal in the storage module 140.

Note that in another embodiment of the application, the second position data and the setting data corresponding to the second position data may also be obtained from the cloud server, and the processor unit 130 may receive the second position data and the setting data corresponding to the second position data via the wireless communication module 110/120 and then store the second position data and the setting data corresponding to the second position data in the storage module, and the application should not be limited to either way of implementation.

In addition, according to yet another embodiment of the application, the storage module 140 may be configured to store one or more time data, the second position data corresponding to the time data and the setting data corresponding to the second position data. The time data and the second position corresponding to the time data may be, for example, the schedule records input by the user as discussed above or the other records calculated by the electronic device. The processor unit 130 may further determine whether the time at which the acoustic sensor 170 is triggered to receive the sound matches the time data. When the processor unit 130 determines that the time at which the acoustic sensor 170 is triggered to receive the sound matches the time data, the processor unit 130 determines the second position data according to the time data, determines the setting data according to the second position data, and the signal-processing unit 150 processes the sound signal according to the setting data to generates the audio signal.

To be more specific, according to an embodiment of the application, the time data may comprise a first time and a second time. When the time at which the acoustic sensor 170 is triggered to receive the sound falls in an interval between the first time and the second time, the processor unit 130 may determine that the time at which the acoustic sensor 170 is triggered to receive the sound matches the time data. Note that the time data, the second position data corresponding to the time data and the setting data corresponding to the second position data may also be obtained from the cloud server, and the processor unit 130 may receive the time data, the second position data corresponding to the time data, and the setting data corresponding to the second position data via the wireless communication module 110/120, and then store the time data, the second position data, and the setting data corresponding to the second position data in the storage module 140, and the application should not be limited to either way of implementation.

When the processor unit 130 obtains the first/second position data, the processor unit 130 may further determine a recording scenario according to the first/second position data. For example, the recording scenario may be indoor, outdoor, an open space, a confined space, or others. The indoor recording scenario may further comprise a conference, a lecture, a meeting, or others.

When the recording scenario is decided, the processor unit 130 may further obtain one or more environment parameters according to the recording scenario. According to an embodiment of the application, the environment parameters may comprise one or more of an area of a space, a number of people in a space, an amount of noise interference in a space and an amount of echo interference in a space, where the space may be the indoor space, outdoor space, open space, confined space, a meeting room, an auditorium room, a conference room, home, or a personal office, or others decided from the first/second position information. In the embodiments of the application, the first/second position information may be regarded as comprising one or more environment parameters as discussed above.

According to an embodiment of the application, the environment parameters may be obtained by a cloud computing system or a computing device (such as the processor unit 130, the signal-processing unit 150, or other device) of the electronic device via multiple times of adaptive training. For example, the electronic device 100 may estimate the environment parameters according to the signals received from each environment (or, the above-mentioned space), and the environment parameters estimated at different time may be adaptively trained locally or in the cloud so as to obtain the optimum environment parameters. In addition, the environment parameters may also be input by users or may be input by users and then adaptively trained for several times to obtain the optimum environment parameters.

In addition, one or more environment parameters corresponding to each recording scenario may be stored in the cloud server or in the storage module 140 of the electronic device 100. When the environment parameters are stored in the cloud server, the electronic device 100 may further obtain the one or more environment parameters corresponding to a current recording scenario from the cloud server.

When the processor unit 130 obtains the environment parameters corresponding to the recording scenario, the processor unit 130 may further select a preferred setting data from a plurality of setting data according to the environment parameters. According to an embodiment of the application, the setting data may comprise one or more parameters selected from a group comprising a signal gain, a signal upper limit, a signal lower limit, whether to trigger a noise cancellation mechanism and whether to trigger an echo-cancellation mechanism. The signal gain may represent a gain applied on the digital audio signal. The signal upper limit may represent the upper limit of the amplitude of the audio signal that has to undergo a specific signal processing, where the specific signal processing may be, for example, suppressing the amplitude of the audio signal for the portion having the amplitude that exceeds the signal upper limit. The signal lower limit may represent the lower limit of the amplitude of the audio signal that has to undergo a specific signal processing, where the specific signal processing may be, for example, amplifying the amplitude of the audio signal for the portion having the amplitude that is lower than the signal lower limit. The noise cancellation mechanism is utilized for cancelling the noise in the space, where the noise may be the normal noise, such as the background noise in the indoor or outdoor space. The echo-cancellation mechanism is utilized for cancelling the echo generated by the sound in a space, and the amount of echo and the time at which the echo may be generated may be estimated according to the environment parameters and the audio signal generated by the sound source (for example, a speaker in a space).

According to an embodiment of the application, the setting data may also be obtained from a cloud computing system or a computing device (such as the processor unit 130, the signal-processing unit 150, or other device) of the electronic device via multiple times of adaptive training. For example, the electronic device 100 or the cloud computing system may perform adaptive training according to the recording results obtained at different time, so as to obtain the optimum setting data. The setting data may be stored in the cloud server or the storage module 140 of the electronic device 100. When the setting data is stored in the cloud server, the electronic device may further select a preferred setting data among a plurality of setting data from the cloud server according to the environment parameters.

When the processor unit 130 obtains the preferred setting data, the processor unit 130 may further provide the preferred setting data to the signal-processing unit 150. The signal-processing unit 150 may further process the digital audio signal according to the preferred setting data to generate the processed audio signal.

In addition, according to an embodiment of the application, the processor unit 130 may further analyze signal quality of the processed audio signal, adjust content of the setting data according to the signal quality, and store the adjusted setting data back in the storage module 140 or the cloud computing system. The adjustment procedure may be performed alone or may be integrated in the above mentioned adaptive training procedures, and the application should not be limited to either way of implementation.

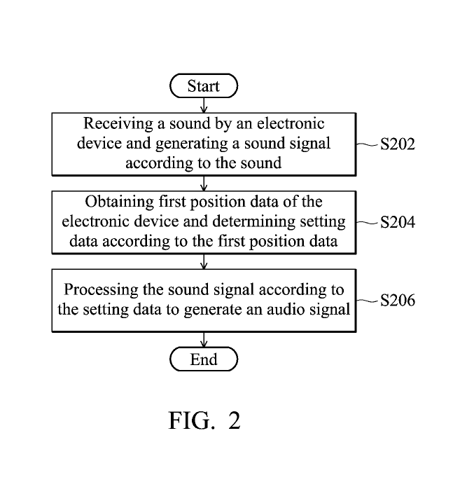

FIG. 2 shows a flow chart of an audio signal processing method according to an embodiment of the application. First of all, the electronic device receives a sound and generates a sound signal according to the sound (Step S202). Next, first position data of the electronic device is obtained and setting data is determined according to the first position data (Step S204). Next, the sound signal is processed according to the setting data to generate an audio signal (Step S206). Note that when the acoustic sensor 170 receives a recording stop indication signal, the audio signal processing procedure is ended. The recording stop indication signal may be generated by the processor unit 130 based on user's operation. For example, when the user execute the recording program and/or press the recording stop button (no matter whether a physical button or a button shown via the User Interface is pressed), the processor unit 130 may generate a corresponding recording stop indication signal so as to trigger the acoustic sensor 170 to stop recording.

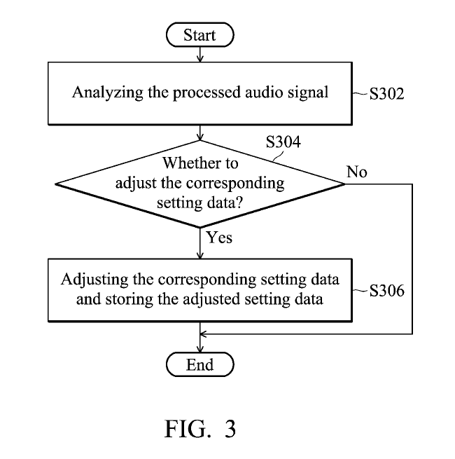

FIG. 3 shows a flow chart of an audio signal processing method according to another embodiment of the application. First of all, the audio signal processed in step S206 is analyzed to obtain a recording quality (Step S302). Next, whether to adjust the corresponding setting data is determined according to the analysis results and/or the recording quality (Step S304). If so, the corresponding setting data is adjusted and the adjusted setting data is stored (Step S306). If not, the process is ended without any further action. Note that the process as shown in FIG. 3 may be executed after the process shown in FIG. 2 is ended, or executed before the process shown in FIG. 2 is ended, and the application is not limited to either way of implementation.

The above-described embodiments of the present application can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

While the application has been described by way of example and in terms of preferred embodiment, it is to be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. An electronic device, comprising:
an acoustic sensor, configured to receive a sound and generate a sound signal according to the sound;
a storage module;
a signal-processing unit, coupled to the acoustic sensor for receiving the sound signal, processing the sound signal according to setting data and accordingly generating an audio signal; and
a processor unit, coupled to the signal-processing unit, obtaining first position data of the electronic device, determining the setting data according to the first position data and storing the audio signal in the storage module.

2. The electronic device as claimed in claim 1, further comprising a wireless module coupled to the processor unit and configured to receive a wireless signal, wherein the processor unit determines the first position data according to the wireless signal.

3. The electronic device as claimed in claim 2, wherein the wireless module comprises a Satellite Navigation System (SNS) signal receiver, the SNS signal receiver receives the wireless signal, and the processor unit determines the first position data according to the wireless signal.

4. The electronic device as claimed in claim 1, further comprising a Satellite Navigation System (SNS) signal receiver and a wireless communication module, the SNS signal receiver receives at least a SNS signal, the processor unit determines longitude and latitude data of the electronic device according to the SNS signal and transmits the longitude and latitude data to a server via the wireless communication module, and the processor unit further receives the first position data of the electronic device generated by the server based on the longitude and latitude data via the wireless communication module.

5. The electronic device as claimed in claim 2, wherein the storage module is configured to store second position data and setting data corresponding to the second position data, the processor unit determines the first position data of the electronic device according to the wireless signal and determines whether the first position data matches the second position data, and when the first position data matches the second position data, the signal-processing unit processes the sound signal according to the setting data corresponding to the second position data to generate the audio signal.

6. The electronic device as claimed in claim 2, further comprising a wireless communication module, wherein the processor unit receives second position data and setting data corresponding to the second position data via the wireless communication module and stores the second position data and the setting data corresponding to the second position data in the storage module.

7. The electronic device as claimed in claim 2, wherein the storage module is configured to store time data, second position data corresponding to the time data, and setting data corresponding to the second position data, and when the processor unit determines that a time at which the acoustic sensor is triggered to receive the sound matches the time data, the processor unit determines the second position data according to the time data, determines the setting data according to the second position data, and processes the sound signal according to the setting data to generates the audio signal.

8. The electronic device as claimed in claim 7, wherein the time data comprises a first time and a second time, and when the time at which the acoustic sensor is triggered to receive the sound falls in an interval between the first time and the second time, the processor unit determines that the time at which the acoustic sensor is triggered to receive the sound matches the time data.

9. The electronic device as claimed in claim 7, further comprising a wireless communication module, wherein the processor unit receives the time data, the second position data corresponding to the time data and the setting data corresponding to the second position data via the wireless communication module, and stores the time data, the second position data, and the setting data in the storage module.

10. The electronic device as claimed in claim 1, wherein the first position data comprises one or more environment parameters, and the environment parameters comprise one or more of an area of a space, a number of people in a space, an amount of noise interference in a space and an amount of echo interference in a space.

11. The electronic device as claimed in claim 1, wherein the setting data comprises at least one of a signal gain, a signal upper limit, a signal lower limit and whether to trigger an echo-cancellation mechanism.

12. The electronic device as claimed in claim 1, wherein the processor unit further determines signal quality according to the audio signal and adjusts the setting data according to the signal quality, and wherein the signal-processing unit further processes the sound signal according to the adjusted setting data to generate the audio signal.

13. The electronic device as claimed in claim 5, wherein the processor unit further determines signal quality according to the audio signal, adjusts the setting data according to the signal quality, and stores the adjusted setting data in the storage module.

14. An audio signal processing method, comprising:
receiving a sound by an electronic device and generating a sound signal according to the sound;
obtaining first position data of the electronic device and determining setting data according to the first position data; and
processing the sound signal according to the setting data to generate an audio signal.

15. The method as claimed in claim 14, further comprising:
receiving a wireless signal and determining the first position data according to the wireless signal.

16. The method as claimed in claim 14, further comprising:
receiving at least a Satellite Navigation System (SNS) signal;
determining longitude and latitude data of the electronic device according to the SNS signal;
transmitting the longitude and latitude data to a server; and
receiving the first position data of the electronic device generated by the server based on the longitude and latitude data.

17. The method as claimed in claim 15, further comprising:
determining whether the first position data matches second position data stored in a storage module of the electronic device; and
when the first position data matches the second position data, processing the sound signal according to the setting data corresponding to the second position data to generate the audio signal.

18. The method as claimed in claim 15, further comprising:
receiving second position data and setting data corresponding to the second position data; and
storing the second position data and the setting data corresponding to the second position data in a storage module of the electronic device.

19. The method as claimed in claim 14, further comprising:
storing time data, second position data corresponding to the time data, and setting data corresponding to the second position data in a storage module of the electronic device;
determining whether a time at which the sound is received matches the time data; and
when the time at which the sound is received matches the time data, determining the setting data according to the second position data, and processing the sound signal according to the setting data to generate the audio signal.

20. The method as claimed in claim 19, wherein the time data comprises a first time and a second time, and the method further comprises:
determining whether the time at which the sound is received falls in an interval between the first time and the second time,
wherein when the time at which the sound is received falls in the interval between the first time and the second time, determining that the time at which the sound is received matches the time data.

21. The method as claimed in claim 19, further comprising:
receiving the time data, the second position data corresponding to the time data, and the setting data corresponding to the second position data via a wireless communication module of the electronic device; and
storing the time data, the second position data, and the setting data in a storage module of the electronic device.

22. The method as claimed in claim 14, wherein the first position data comprises one or more environment parameters, and the environment parameters comprise one or more of an area of a space, a number of people in a space, an amount of noise interference in a space and an amount of echo interference in a space.

23. The method as claimed in claim 14, wherein the setting data comprises at least one of a signal gain, a signal upper limit, a signal lower limit and whether to trigger an echo-cancellation mechanism.

24. The method as claimed in claim 14, further comprising:
determining signal quality according to the audio signal;
adjusting the setting data according to the signal quality; and
processing the sound signal according to the adjusted setting data to generate the audio signal.

25. The method as claimed in claim 17, further comprising:
determining signal quality according to the audio signal;
adjusting the setting data according to the signal quality; and
storing the adjusted setting data in the storage module.
